(19) United States
(12) Patent Application Publication
(10) Pub. No.: US 2015/0114121 A1
(43) Pub. Date: Apr. 30, 2015

(54) STRUCTURE ANALYZING DEVICE AND A STRUCTURE ANALYZING METHOD

(71) Applicants: Masatake Takahashi, Tokyo (JP); Shigeki Shinoda, Tokyo (JP); Yasuhiro Sasaki, Tokyo (JP)

(72) Inventors: Masatake Takahashi, Tokyo (JP); Shigeki Shinoda, Tokyo (JP); Yasuhiro Sasaki, Tokyo (JP)

(73) Assignee: NEC CORPORATION, TOKYO (JP)

(21) Appl. No.: 14/405,902

(22) PCT Filed: Jan. 11, 2013
(86) PCT No.: PCT/JP2013/050416

§ 371 Date: Dec. 5, 2014

(30) Foreign Application Priority Data
Jun. 6, 2012 (JP) 2012-129200

(51) Int. Cl. G01N 29/12

(52) U.S. Cl. CPC G01N 29/12; G01N 2291/014
USPC 73/579

(57) ABSTRACT

An object of the invention is to provide a structure analyzing device and a structure analyzing method which can analyze a state change of a structure, which is caused before the structure is destroyed, such as a state change of degradation of the structure or the like. A structure analyzing device (10) according to the present invention includes a vibration detecting means (11) which detects a vibration of a structure, and an analysis means (12) which analyzes an output signal of the vibration detecting means (11). The analysis means (12) analyzes a state change of the structure by comparing a value of at least one out of a vibration amplitude of the structure and a vibration continuation time of the structure, which is measured in a state existing when carrying out analysis, with a value of at least one out of a vibration amplitude of the water service pipe and a vibration continuation time of the water service pipe which is measured in a standard state.

### TECHNICAL FIELD

The present invention relates to a structure analyzing device and a structure analyzing method.

### BACKGROUND ART

In order to ensure safety and secure for a structure such as a high-pressure pipe line, a water and sewage plumbing, a high speed railway, a long span bridge, a high rise building, a large passenger aircraft or a car, non-destructive inspection techniques have been researched and developed. As the non-destructive inspection of the structure, the crack detecting method by penetration inspection and the crack detecting method by ultrasonic inspection are exemplified (for example, refer to a non-patent literature 1). FIG. 11A shows an outline of the crack detecting method by penetration inspection. The crack detecting method by penetration inspection is a method to apply a fluorescent material 2 to a member 1 which is a component of a facility, and to make the fluorescent material 2, which penetrates into a crack 3 corresponding to a defect of the structure, luminous, and to check the crack 3 by inspector's eyes. Since a check based on the method can be carried out with ease, the method is used frequently. FIG. 11B shows an outline of the crack detecting method by ultrasonic inspection. The crack detecting method by ultrasonic inspection is a method to use an ultrasonic transducer 4 which is an electromechanical converter, and to identify a crack 3 of a member 1 by radiating ultrasonic waves to the member 1. The method uses a property that acoustic impedance at a location, at which the crack 3 is caused, is different from acoustic impedance at a normal location. Identification of the crack 3 of the member 1 is carried out through receiving a reflected wave, which is generated by reflection of an ultrasonic wave signal propagating through the member and which is generated at the location of the crack 3, by use of the electromechanical converter.

### CITATION LIST

### Non Patent Literature

NPL 1: Easy non-destructive inspection technique, fifth page, 1996, Kogyo Chosakai Publishing Co., Ltd

### SUMMARY OF INVENTION

### Technical Problem

Since each of the crack detecting method by penetration inspection and the crack detecting method by ultrasonic inspection detects the defect of the structure such as the crack after the defect of the structure is caused, it is difficult to detect a degradation state before the defect is caused. However, once the defect is caused, even if the defect is slight, there is a fear that the defect may bring about a serious result. Therefore, it is requested to realize an inspection method which can detect the degradation state before the defect is caused.

An object of the present invention is to provide a structure analyzing device and a structure analyzing method which can analyze a state change of the structure, for example, a state change of degradation of the structure or the like which is caused before the structure is destroyed.

### Solution to Problem

In order to achieve the above-mentioned object, a structure analyzing device of the present invention includes:

a vibration detecting means which detects a vibration of a structure; and

an analysis means which analyzes an output signal of the vibration detecting means.

The analysis means is a device which analyzes a state change of the structure by comparing a value of at least one out of a vibration amplitude of the structure, and a vibration continuation time of the structure, which is measured in a state existing when carrying out analysis, with a value of at least the one out of the vibration amplitude of the structure and the vibration continuation time of the structure which is measured in a standard state.

A structure analyzing method of the present invention, comprising:

a vibration detecting step in which a vibration of a structure is detected; and

an analysis step in which an output signal in the vibration detecting step is analyzed.

The analysis step is a step in which a state change of the structure is analyzed by comparing a value of at least one out of a vibration amplitude of the structure, and a vibration continuation time of the structure, which is measured in a state existing when carrying out the analysis, with a value of at least the one out of the vibration amplitude of the structure and the vibration continuation time of the structure which is measured in a standard state.

### Advantageous Effects of Invention

According to the structure analyzing device and the structure analyzing method of the present invention, it is possible to analyze the state change of the structure, for example, the state change of the degradation of the structure or the like which is caused before the structure is destroyed.

### BRIEF DESCRIPTION OF DRAWINGS

FIG. 1 is a block diagram showing composition of an example of a structure analyzing device (exemplary embodiment 1) of the present invention.

FIG. 2 is a flowchart showing an example of a structure analyzing method (exemplary embodiment 1) of the present invention.

FIG. 3 is a block diagram showing composition of a modification 1 of the structure analyzing device of the exemplary embodiment 1.

FIG. 4 is a flowchart showing a modification 1 of the structure analyzing method of the exemplary embodiment 1.

FIGS. 5A-5C are diagram showing examples of an input signal of a vibration adder and an output waveform of a vibration sensor in the present invention.

FIG. 6 is a schematic diagram explaining a vibration waveform analyzing method in the present invention.

FIGS. 7A and 7B are schematic diagram explaining a vibration waveform analyzing method in the present invention.

FIGS. 8A-8D are schematic diagram explaining a structure analyzing method in exemplary embodiments 1 and 2 of the present invention.

FIGS. 9A-9C are schematic diagram explaining a structure analyzing method in an exemplary embodiment 3 of the present invention.

FIG. 10 is a block diagram showing composition of an analyzing device of an exemplary embodiment 4 of the present invention.

FIGS. 11A and 11B are schematic diagram showing an outline of a non-destructive inspection technique which is described in a non patent literature 1.

### DESCRIPTION OF EMBODIMENTS

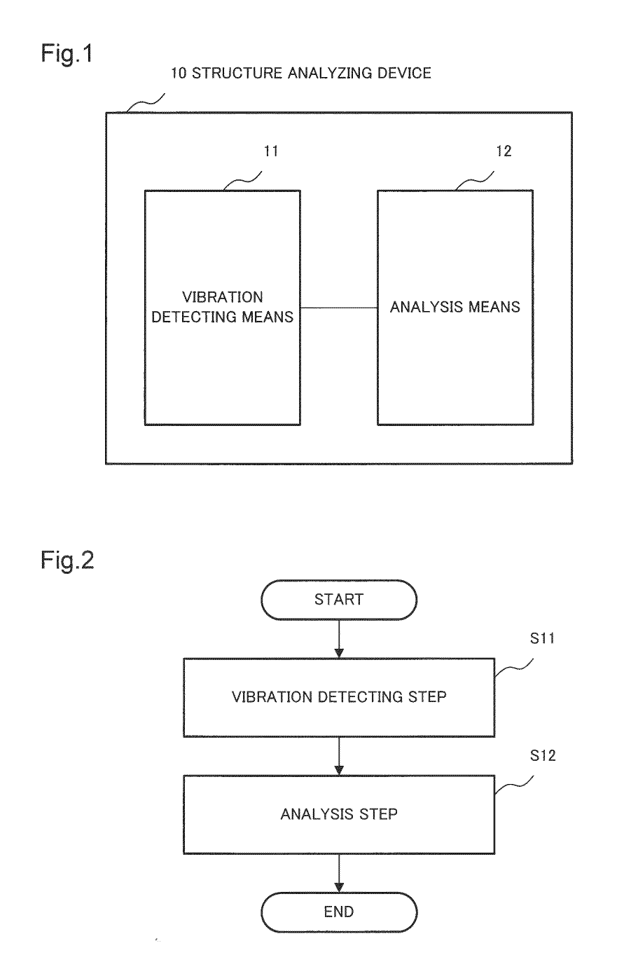

Hereinafter, examples of a structure analyzing device and a structure analyzing method of the present invention will be described in detail with reference to drawings. However, the present invention is not limited to examples which will be described later. Here, in FIGS. 1 to 10 shown in the following, the same code is attached to the same part. Moreover, in each diagram, composition of each unit may be simplified appropriately for convenience of explanation in some cases, and a size ratio or the like of each unit may be indicated schematically, and as a result may be different from an actual size ratio or the like.

### Exemplary Embodiment 1

FIG. 1 is a block diagram showing composition of a structure analyzing device of an exemplary embodiment 1.

As shown in FIG. 1, a structure analyzing device 10 of the exemplary embodiment includes a vibration detecting means 11 and an analysis means 12 as a main component.

The vibration detecting means 11, which is, for example, a vibration sensor, detects a vibration of a structure, and acquires vibration waveform data from the structure. A kind of the vibration sensor is not limited in particular, and the well-known vibration sensor can be applied. Specifically, an acceleration sensor, a velocity sensor and a displacement sensor are exemplified. It is preferable that the acceleration sensor is a piezoelectric type and includes a signal amplifier circuit. It is preferable that the vibration detecting means 11 (vibration sensor) has high sensitivity, and can detect a signal which has a wide frequency bandwidth. A contact type vibration detecting means, which is arranged on the structure, is applicable to the vibration detecting means 11. An arrangement position on the structure is not limited in particular. The vibration detecting means 11 is arranged at an appropriate position on the structure on the basis of a purpose of using the structure analyzing device 10. Moreover, it is also possible to apply a non-contact type vibration detecting means, which can be arranged apart from the structure, to the vibration detecting means 11. For example, by applying a laser Doppler vibrometer or the like to the vibration detecting means 11, a frequency response of a vibration amplitude may be measured optically. Since it is possible to arrange the non-contact type vibration detecting means without coming into contact with the structure which is an analysis target, it is effective to use the non-contact type vibration detecting means in the case that it is impossible to arrange the vibration detecting means on the structure, for example, in the case of a severely uneven area, a hot or cold area, an area on a small member or the like. Moreover, the non-contact type vibration detecting means can be employed even in the case that its weight might cause an influence to the attachment, when being attached to the analysis target structure which is, for example, light or soft. Moreover, in the case that an antenna is arranged in place of the vibration sensor to emit an electromagnetic wave, it is possible to measure the frequency response of the vibration amplitude on the basis of a voltage output response of a reflected wave. In the case of making the antenna move on a surface of the structure in order to scan the surface, and measuring the frequency response of the vibration amplitude, it is possible to obtain the same result as a result which is obtained in the case that a plurality of vibration sensors are arranged to measure the frequency response as mentioned later.

The analysis means 12, which is a means analyzing an output signal of the vibration detecting means 11, analyzes a state change of the structure by comparing a value of at least one out of a vibration amplitude of the structure, and a vibration continuation time of the structure, which is measured in a state existing when carrying out analysis, with a value of at least the one out of the vibration amplitude of the structure and the vibration continuation time of the structure which is measured in a standard state. The standard state is, for example, a state measured before the state change is caused. That is, in the case of analyzing degradation of the structure, the standard state means a normal state in which the degradation is not caused. It is preferable that the value measured in the standard state is stored, for example, in a storage means, and the analysis means reads the value, which is measured in the standard state, from the storage means, and compares the value, which is measured in the state existing when carrying out the analysis, with the value which is measured in the standard state.

The structure analyzing method of the exemplary embodiment carries out the following steps, which are shown in FIG. 2, with using the structure analyzing device shown in FIG. 1.

First, the vibration detecting means 11 detects the vibration of the structure which is a detection target, and acquires the vibration waveform data (vibration detecting step (Step S11))

Next, the analysis means 12 analyzes the output signal of the vibration detecting means 11 which is the vibration waveform data acquired from the vibration detecting means 11 (analysis step (Step S12)). The analysis step (S12) is a step to analyze the state change of the structure, structure of at least one out of the vibration amplitude and a vibration continuation time in the state existing when carrying out analysis, which is measured in the standard state.

A feature of the present invention is to detect the state change (for example, mechanical distortion of the structure) due to the vibration by use of the arranged vibration detecting means, and to measure a maximum amplitude value and a vibration attenuation rate σ of a mechanically free vibration, which are determined by stiffness, mass, and a mechanical resistance of the structure, on the basis of a time response of the vibration amplitude. The maximum amplitude value is inversely proportional to a mechanical resistance R of the structure. Moreover, a relation among the vibration attenuation rate σ, a mechanical resistance R, and mass M of the structure is expressed in a formula σ∝R/M. For example, when force is applied to the structure from the outside, mechanical distortion is caused to the structure, and an atom which is included in the structure is moved, and afterward coupling among the atoms is disconnected and consequently the structure results in being damaged (being caused defects). When an atom is moved, mechanical characteristics, especially, the stiffness and the mechanical resistance change. According to the present invention, by measuring changes of the maximum amplitude value and the vibration attenuation rate σ of the mechanically free vibration, it is possible to carry out a quantitative evaluation with high level accuracy of these changes as the state of degradation of the sign of structural defects are caused.

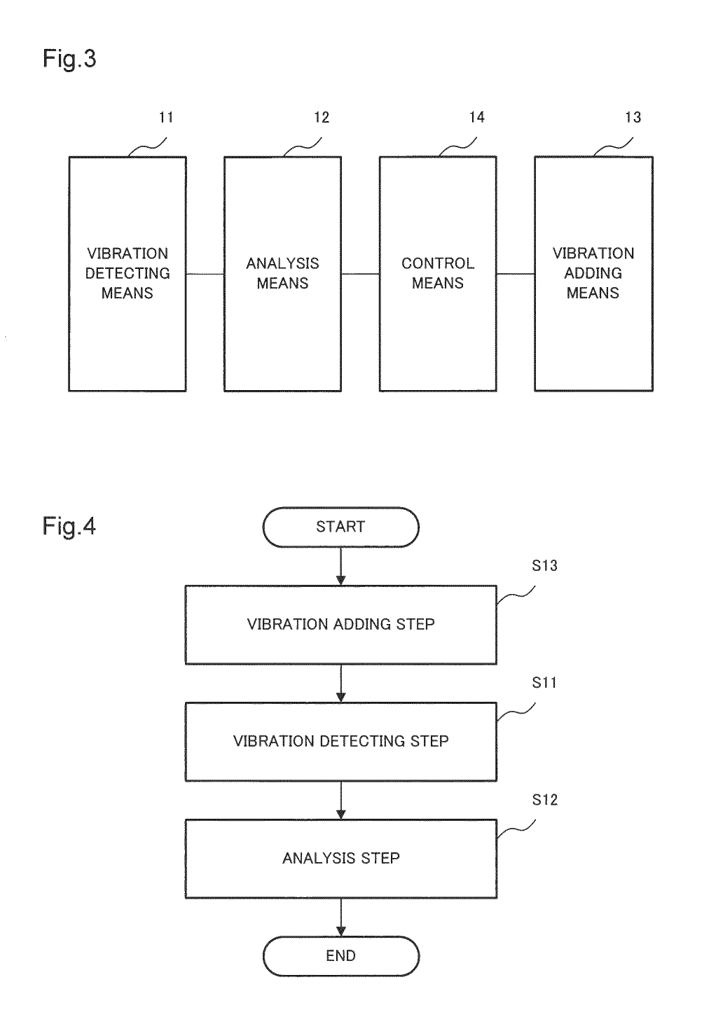

It is also preferable that the vibration, which is detected by the vibration detecting means 11, is added to the structure by a vibration adding means which vibrates the structure, and it is preferable that the structure analyzing device of the exemplary embodiment includes the vibration adding means furthermore. FIG. 3 is a block diagram showing composition of a structure analyzing device, which includes the vibration adding means, according to a modification 1 of the exemplary embodiment 1. Moreover, FIG. 4 is a flowchart showing a structure analyzing method in the modification 1. As shown in FIG. 3, the analyzing device of the modification 1 includes a vibration adding means 13 and a control means 14 in addition to the vibration detecting means 11 and the analysis means 12. The control means 14, which is a means to control the vibration detecting means 11, the analysis means 12 and the vibration adding means 13, includes, for example, a constant voltage oscillation circuit or the like, and applies a vibration waveform to the vibration adding means 13 to vibrate the vibration adding means 13. The control means 14 is an optional component, and may not be included in the structure analyzing device, but it is preferable that the control means is included. Except for this point, the structure analyzing device shown in FIG. 3 has the same composition as the structure analyzing device 10 shown in FIG. 1 has. The structure analyzing method of the modification 1 includes a vibration adding step (S13) before the vibration detecting step (S11). Except for this point, the structure analyzing method shown in FIG. 4 includes the same step as the structure analyzing method shown in FIG. 2 includes.

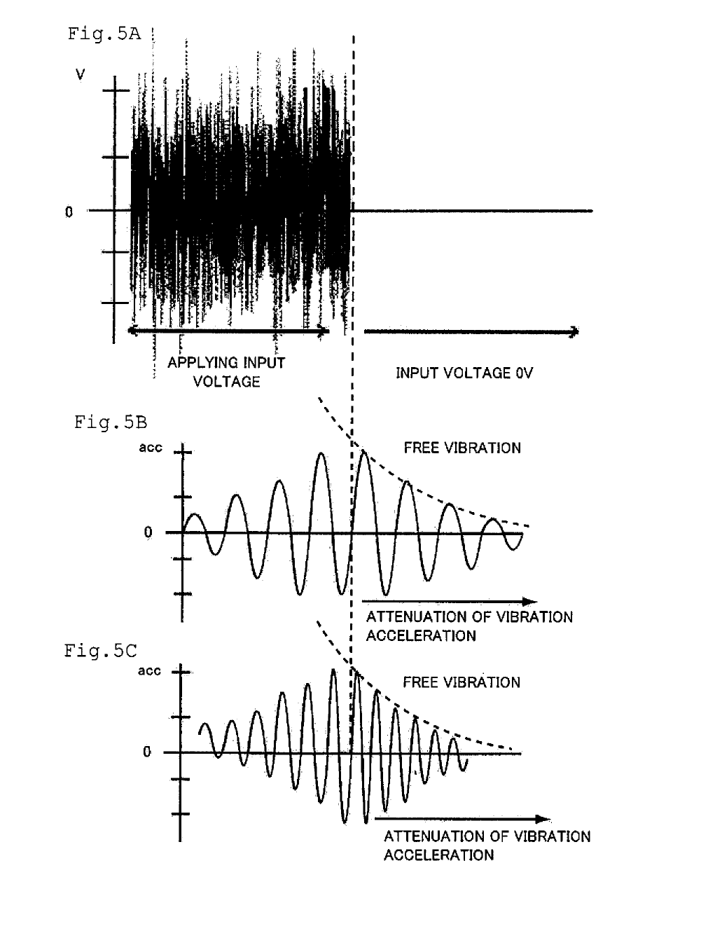

It is enough if the vibration adding means 13 can add the vibration to the structure of the analysis target. For example, a vibration adder, a speaker or the like is applicable to the vibration adding means 13, and can be selected appropriately according to a measurement environment or the like. The vibration adder receives an alternating voltage waveform of predetermined amplitude and frequency bandwidth (for example, refer to FIG. 5 (a)), from the constant voltage oscillator for a predetermined time, and vibrates the structure of the analysis target, with vibration energy into which the applied electric energy is converted. In the case of using the speaker, the speaker emits sound waves, and vibrates the structure of the analysis target.

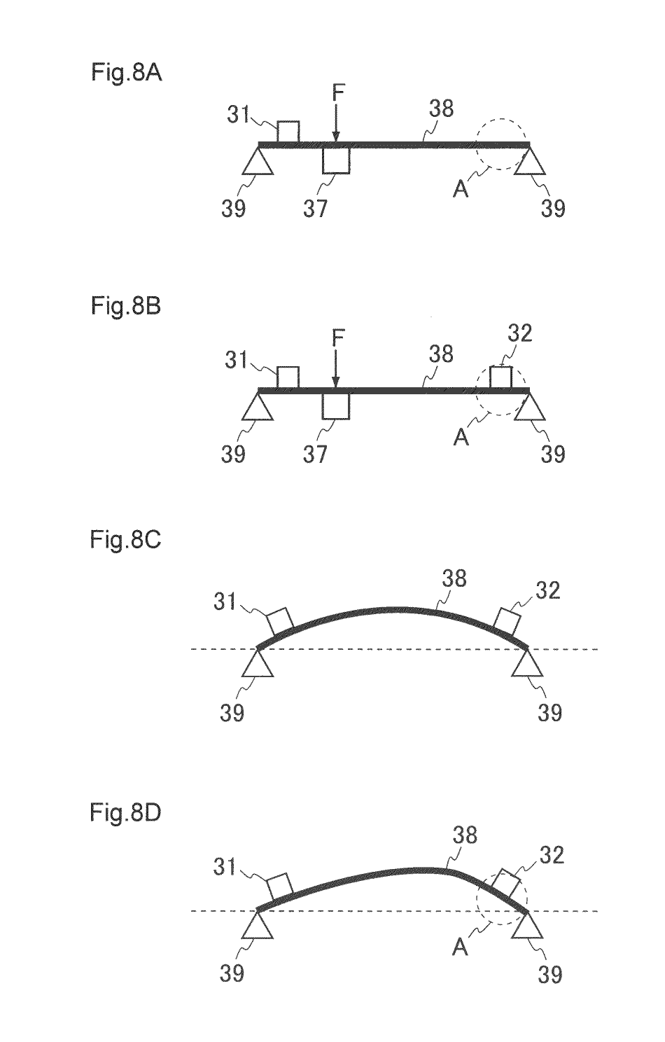

Here, a mechanism of the structure analyzing method of the present invention will be described with reference to FIG. 8. FIG. 8A is a model diagram showing a case that a measurement object 38, on which a vibration sensor 31 is arranged, is arranged on a pedestal 39, and is vibrated by a vibration adder 37. An A part of the measurement object 38 is caused mechanical degradation as time passes, and then the analysis is carried out. The vibration adder 37 adds the vibration, for example, according to the following way. First, the vibration adder 37 is arranged at a position F, and adds the vibration to the measurement object 38. At this time, a plurality of mechanical resonant mode is excited to the measurement object 38, by the input of vibration energy which is provided by the vibration adder 37. After adding the vibration is stopped, free vibrations corresponding to the excited mechanical resonant modes overlap. The vibration sensor 31 outputs a voltage signal according to the vibration of the measurement object. FIGS. 5(b) and (c) exemplifies waveforms acquired by an electric filter's extracting only a basic component and a second harmonic component, respectively, out of a plurality of free vibrations. Each of vibration amplitudes attenuates due to internal friction of the measurement object 38, as time passes.

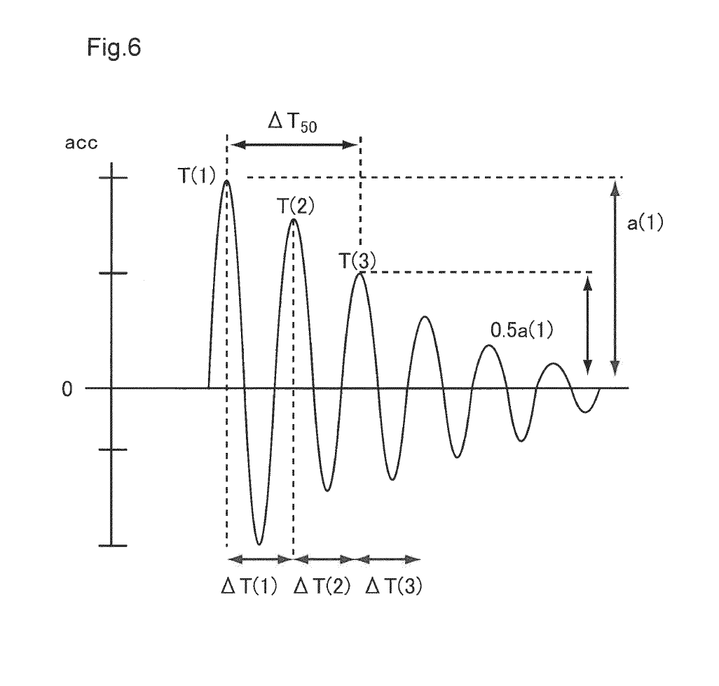

The vibration sensor 31 outputs the voltage signal according to the vibration amplitude of the measurement object 38. FIG. 6 exemplifies a typical free vibration waveform. FIG. 6 shows that the vibration waveform has the maximum value a(1) at a time T(1). Moreover, FIG. 6 shows that a value of the vibration waveform at a time T(3) is half of the maximum value. a(1) and T(3) are defined as the maximum value of vibration amplitude and an attenuation time, respectively. Then, each of the vibration amplitude and the attenuation rate σ is used as an index for analyzing mechanical characteristics of the measurement object 38. Here, the maximum value of vibration amplitude, which is measured by a vibration sensor i arranged on the measurement object, is denoted as aᵢⱼₖ and the attenuation time is denoted as ΔT(50)ᵢⱼₖ, where i is the number which identifies the arranged vibration sensor, j is the number assigned to the resonant mode expressed as j=1, 2, 3 . . . indicating ascending order of frequency, and k, which indicates an order determined according to a length of time when the measurement object is used, is expressed as k=1, 2, 3 . . . in turn according to the length of time, that is, from an unused measurement object, in other word, from the measurement object which is not degraded.

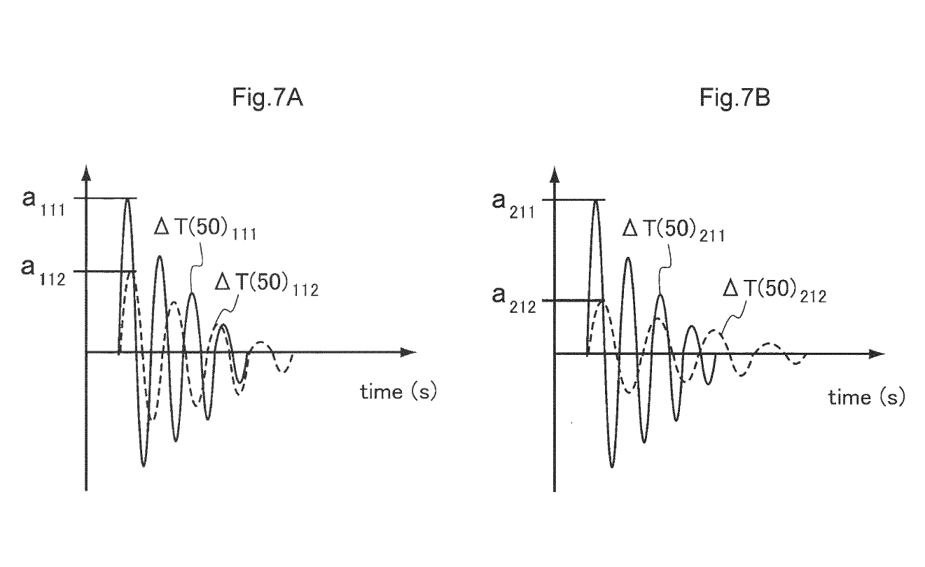

As shown in FIG. 7A, as the time when the measurement object is used becomes long, that is, as k=1, 2, 3, . . . , the mechanical degradation is caused according to durability of the structure, and consequently the attenuation time (vibration continuation time) ΔT(50)ᵢⱼₖ is changed together with the maximum value of vibration amplitude aᵢⱼₖ which is measured by the vibration sensor 31. At this time, it is possible to carry out a quantitative evaluation on a degree of degradation of the structure by use of formulas of aᵢⱼₖ/aᵢⱼ₁, and ΔT(50)ᵢⱼₖ/ΔT(50)ᵢⱼ₁ which are aᵢⱼₖ normalized by aᵢⱼ₁, and ΔT(50)ᵢⱼₖ normalized by ΔT(50)ᵢⱼ₁ respectively. Here, according to the method which is described in Background Art, it is impossible or difficult to detect an internal change which indicates a stage (sign) of being just before the structure is caused to the damage. On the other hand, according to the present invention, it is possible to grasp such the degradation state.

### Exemplary Embodiment 2

According to the exemplary embodiment, a plurality of vibration detecting means 11 are arranged. Except for this point, a structure analyzing device and a structure analyzing method of the exemplary embodiment have the same composition as the structure analyzing device and the structure analyzing method of the exemplary embodiment 1 respectively have.

A mechanism of the structure analyzing method, which is used in the case that two vibration sensors of the vibration sensor 31 and a vibration sensor 32 are arranged on the measurement object 38 as shown in FIG. 8B, will be described. In FIG. 8B, the vibration adder 37 is arranged at a position F on the measurement object 38, and vibrates the measurement object 38. Mechanical degradation is caused at an A part of the measurement object 33 as time passes. The vibration sensor 32 is arranged just on the A part (degradation position). FIG. 7B shows a time response which is measured by the vibration sensor 32 and which is related to a basic resonance. FIG. 7B is corresponding to FIG. 7A which shows a measurement result provided by the vibration sensor 31. A response change shown in FIG. 7B is large in comparison with one shown in FIG. 7A. In this case, since mechanical distortion becomes large at the degradation position A, the measurement value reflects the response sensitively. In the case that the vibration sensor is arranged just on the degradation position as mentioned above, the response change becomes large. As a result, it is found that it is possible to inspect (analyze) a degree of degradation with high level precision. Furthermore, it is possible to carry out analysis such as identification of the degradation position or the like in comparison with largeness of a response change of a sensor which is arranged at another position.

### Exemplary Embodiment 3

According to the present exemplary embodiment, the vibration adding means 13 adds a vibration, which includes a high order resonant frequency component, to the structure and causes the structure a high order resonant phenomenon. As a result, the vibration adding means 13 causes unevenness (mechanical distortion) of vibration amplitude at a plurality of positions. Then, an analysis is carried out on the basis of the unevenness. Except for this point, a structure analyzing device and a structure analyzing method of the exemplary embodiment have the same composition those of the exemplary embodiment 1 or 2.

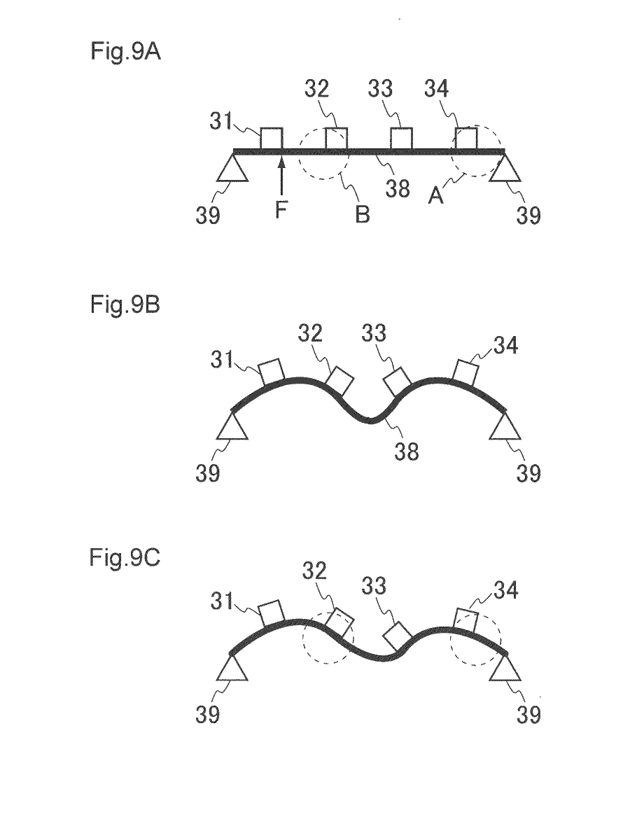

Each of FIG. 9A to FIG. 9C shows an example that vibration sensors 31, 32, 33 and 34 are arranged on the measurement object 38. Specifically, the example shows that the vibration sensor 32 and the vibration sensor 34 are arranged just on a B part and an A part, respectively, of the measurement object 38, and mechanical degradation is caused at the A part and the B part as time passes. FIG. 9A shows a stationary state, and each of FIGS. 9B and 9C shows a vibration addition state of causing the structure the high order resonant phenomenon, that is, causing the structure the unevenness (mechanical distortion) of the vibration amplitude at a plurality of positions. In this example, a case of a third order resonance will be described. As mentioned above, in the case of causing the structure the unevenness (mechanical distortion which is caused at a plurality of points) of the vibration amplitude at the plural points, the mechanical distortion at the plural degradation positions A and B become large, and therefore a measurement value reflects the response sensitively. That is, in the case of a high order mechanical resonant mode, an area in which the vibration amplitude is uneven occupies a small area on the measurement object, and influence of the mechanical distortion, which is caused locally, becomes severe. In this case, when comparing outputs, which a plurality of vibration sensors generate at each resonant frequency, with reference to values which are measured in a normal state (corresponding to the standard state in the exemplary embodiment 1), the sensor position, each the maximum value of vibration amplitude aᵢⱼₖ and each the vibration continuation time ΔT(50)ᵢⱼₖ reflect the degradation position and a degree of degradation with high level accuracy. As mentioned above, according to the present exemplary embodiment, it is possible to carry out the analysis, such as evaluation on a degree of degradation of the structure and identification of the degradation position of the structure, with higher level accuracy. While the case of the third order resonance has been explained in the present exemplary embodiment, the present invention is not limited to the case. For example, a second order resonance, a fourth order resonance or the like is applicable. As the high order resonant frequency, a range of the second order to the twentieth order is preferable, and a range of the second order to the tenth order is more preferable. Too high order resonant frequency tends to be difficult to be separated from a next order resonant frequency (if an order is nineteenth, next order is eighteenth or twentieth) and consequently detection becomes difficult. Therefore, it is preferable to adopt the above-mentioned range.

### Exemplary Embodiment 4

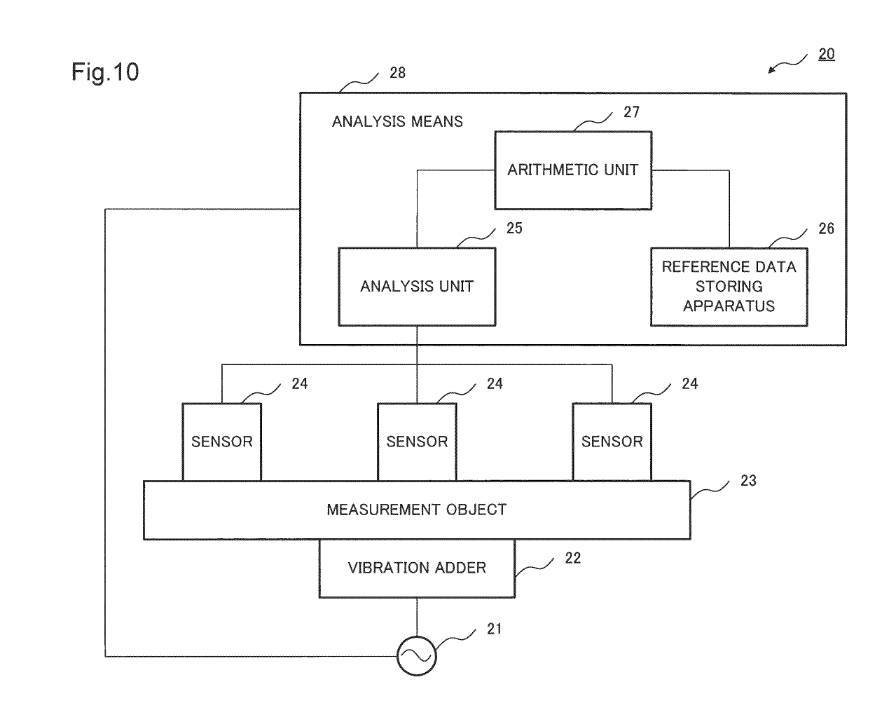

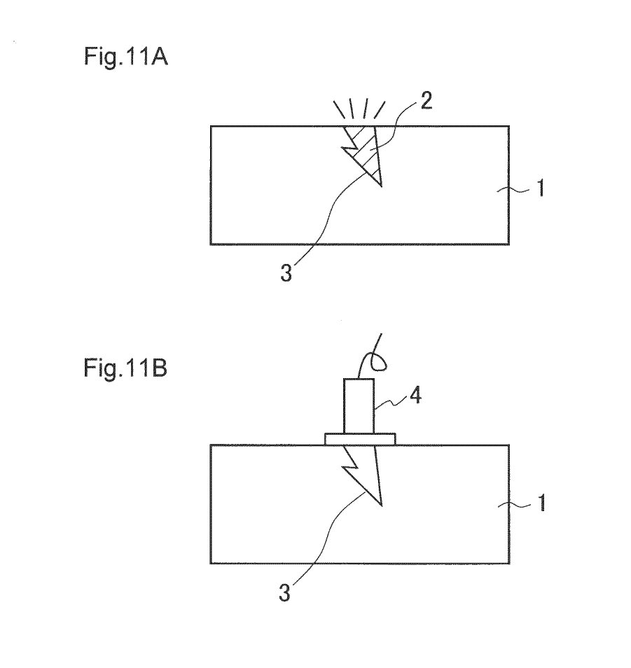

FIG. 10 is a block diagram showing composition of a structure analyzing device of the exemplary embodiment 4 of the present invention. Structure analyzing device 20 includes a constant voltage oscillation circuit 21, a vibration adder (vibration adding means) 22, a vibration acceleration sensor (vibration detecting means) 24 and an analysis means 28. The analysis means 28 includes an analysis unit 25 which calculates the resonant frequency and the resonant sharpness Q, a reference data storing apparatus 26 which stores data, and an arithmetic unit 27 which carries out comparison with reference data, and judgment. As shown in FIG. 10, the structure analyzing device 20 can be arranged on an analysis object structure (measurement object) 23, for analysis. As mentioned above, the vibration adder 22 may be attached to the measurement object 23 or may not contact with the measurement object 23.

### Exemplary Embodiment 5

The structure analyzing device and the structure analyzing method of the present invention are applicable to, for example, a water leak detecting device and a water leak detecting method, respectively. In the case of application to the water leak detection, the vibration detecting means of the structure analyzing device detects a vibration of a water service pipe such as a water intake pipe, a water conducting pipe, a water distributing pipe, a water supplying pipe or the like. A location where the vibration detecting means is arranged may be, for example, a manhole, a fire hydrant, a water stopping valve, the water service pipe such as the water intake pipe, the water conducting pipe, the water distributing pipe, the water supplying pipe or the like. For example, when the water conducting pipe enters into an abnormal state, and consequently an abnormal vibration and an abnormal sound are caused by leaked water, the vibration detecting means detects the abnormal vibration, and a vibration due to the abnormal sound, and the analysis means compares a value of at least one of a vibration amplitude of the water conducting pipe and a vibration continuation time of the water conducting pipe, which is measured in a state existing when carrying out analysis, with a value of at least one of a vibration amplitude of the water conducting pipe and a vibration continuation time of the water conducting pipe which is measured in a standard state which means that the water conducting pipe is in a non-abnormal state. As a result, it is possible to analyze a degradation state of the water conducting pipe. Similarly to the case of the water conducting pipe, it is possible to analyze a degradation state of the water service pipe other than the water conducting pipe.

### Exemplary Embodiment 6

The structure analyzing device and the structure analyzing method of the present invention are applicable to, for example, an intrusion-into-building detecting device and an intrusion-into-building detecting method, respectively. In the case of application to the intrusion detection, a location where the vibration detecting means of the structure analyzing device is arranged is, for example, a window frame, glass, a door, a floor surface, a pillar or the like. By arranging the vibration detecting means on the window frame of the building, it is possible to detect an act related to intrusion, such as an act of destroying the window, unlocking the window, opening and closing the window or the like. The vibration detecting means detects a vibration due to the act related to the intrusion, and the analysis means compares a value of at least one out of a vibration amplitude and a vibration continuation time, which is measured in a state existing when carrying out analysis, with a value of at least one out of a vibration amplitude and a vibration continuation time which is measured in a standard state meaning a non-abnormal state. As a result, it is possible to analyze presence or absence of intrusion act.

### Exemplary Embodiment 7

The structure analyzing device and the structure analyzing method of the present invention are applicable to, for example, a structure's degradation detecting device and a structure's degradation detecting method, respectively. In the case of application to the structure's degradation detection, a location where the vibration detecting means of the structure analyzing device is arranged is, for example, a wall, a pillar, a beam, a floor, a foundation or the like of a building, a house or the like. For example, when that the structure degrades, an abnormal vibration and an abnormal sound due to the degradation are caused. The vibration detecting means detects the abnormal vibration, and a vibration due to the abnormal sound, and the analysis means compares a value of at least one out of a vibration amplitude and a vibration continuation time, which is measured in a state existing when carrying out analysis, with a value of at least one out of a vibration amplitude and a vibration continuation time which is measured in a standard state meaning that the structure is in a non-abnormal state. As a result, it is possible to analyze a degradation state of the structure.

### EXAMPLE

### Example 1

Analysis of the structure, which has the composition shown in the block diagram of FIG. 10, was carried out by use of the structure analyzing device 20. As the analysis target structure 23, a stainless steel plate whose length, width and thickness are 40 cm, 1 cm and 5 mm, respectively, was prepared. A steel ball whose weight was 1 kg was dropped repeatedly from a height of 1 m at a position, which was far from a left end of the stainless steel plate by 12 cm in a longitudinal direction of the stainless steel plate, to make the steel ball collide with the stainless steel plate. Before the steel ball was dropped, after the steel ball was dropped 1000 times, and after the steel ball was dropped 5000 times, a state that both ends of the stainless steel plate were supported mechanically was set as shown in FIG. 9A.

The vibration adder 22 was arranged at a position far from the left end of the stainless steel plate by 5 cm on the stainless steel plate, and was driven by an electric signal made of the white noise whose frequency bandwidth was limited from 10 Hz to 10 kHz. Then, the vibration adder 22 vibrates the stainless steel plate with force of 1N. The vibration acceleration sensors 24 were arranged at four different positions far from the left side of the stainless steel plate by 5 cm, 15 cm, 25 cm and 35 cm, on the stainless steel plate, and voltage outputs, which were based on the positions where the sensors were arranged and which are proportional to the vibration amplitude of the structure, were acquired.

Next, the analysis unit 25 finds a basic resonant frequency on the basis of a vibration time waveform which is in a free vibration state, and a digital filter included in the analysis unit 25 extracted the basic resonant frequency component. As a result, the maximum value of vibration amplitude aᵢⱼₖ and a vibration continuation time ΔT(50)ᵢⱼₖ were found (j=1). Furthermore, by calculating ratios of the maximum value of vibration amplitude aᵢⱼₖ and the vibration continuation time ΔT(50)ᵢⱼₖ, which were acquired after the 1000 times steel ball dropping test, to the maximum value of vibration amplitude aᵢⱼₖ and the vibration continuation time ΔT(50)ᵢⱼₖ respectively which were acquired before the steel ball dropping test, and calculating ratios of the maximum value of vibration amplitude aᵢⱼₖ and the vibration continuation time ΔT(50)ᵢⱼₖ, which were acquired after the 5000 times steel ball dropping test, respectively which were acquired before the steel ball dropping test, to the maximum value of vibration amplitude aᵢⱼₖ and the vibration continuation time ΔT(50)ᵢⱼₖ, a degradation position was identified and a degree of degradation was evaluated. The result is shown in a table 1. Since it was found that, as number of the steel ball dropping tests increases, changes of the maximum value of vibration amplitude aᵢⱼₖ and the vibration continuation time ΔT(50)ᵢⱼₖ could be recognized clearly by use of only the vibration sensor which was arranged near the position where the steel ball was dropped, it was confirmed that it was possible to identify the degradation position and to evaluate a degree of degradation with high level accuracy.

TABLE 1

| | | | Position | | Position | | | |
|---|---|---|---|---|---|---|---|---|
| | Position 5 cm | | 15 cm | | 25 cm | | Position 35 cm | |
| | a₁₁ₖ/ | ΔT(50)₁₁ₖ/ | a₂₁ₖ/ | ΔT(50)₂₁ₖ/ | a₃₁ₖ/ | ΔT(50)₃₁ₖ/ | a₄₁ₖ/ | ΔT(50)₄₁ₖ/ |
| | a₁₁₁ | ΔT(50)₁₁₁ | a₂₁₁ | ΔT(50)₂₁₁ | a₃₁₁ | ΔT(50)₃₁₁ | a₄₁₁ | ΔT(50)₄₁₁ |
| Before steel | 1 | 1 | 1 | 1 | 1 | 1 | 1 | 1 |
| ball | | | | | | | | |
| dropping | | | | | | | | |
| test | | | | | | | | |
| After 1000 | 1 | 1 | 0.98 | 0.95 | 1 | 1 | 1 | 1 |
| times steel | | | | | | | | |
| ball | | | | | | | | |
| dropping | | | | | | | | |
| tests | | | | | | | | |
| After 5000 | 1 | 1 | 0.95 | 0.90 | 1 | 1 | 1 | 1 |
| times steel | | | | | | | | |
| ball | | | | | | | | |
| dropping | | | | | | | | |
| tests | | | | | | | | |

### Example 2

Similarly to the example 1, the test of dropping the steel ball against the stainless steel plate was carried out. In this case, the maximum value of vibration amplitude aᵢⱼₖ and a vibration continuation time ΔT(50)ᵢⱼₖ at a third order resonant frequency (j=3) were used for identifying a degradation position and evaluating a degree of degradation. The result is shown in a table 2. A change of an output value of the sensor, which was arranged near to the position where the steel ball was dropped, was observed similarly to the example 1, and the change of the output value was large in comparison with the change according to the example 1. It was conceivable that the measurement reflected a degree of degradation sensitively since the large mechanical distortion was caused at the high order resonant frequency. It was confirmed that an accurate measurement was carried out by using the high order resonant frequency as mentioned above.

TABLE 2

| | | | Position | | Position | | | |
|---|---|---|---|---|---|---|---|---|
| | Position 5 cm | | 15 cm | | 25 cm | | Position 35 cm | |
| | a₁₃ₖ/ | ΔT(50)₁₃ₖ/ | a₂₃ₖ/ | ΔT(50)₂₃ₖ/ | a₃₃ₖ/ | ΔT(50)₃₃ₖ/ | a₄₃ₖ/ | ΔT(50)₄₃ₖ/ |
| | a₁₃₁ | ΔT(50)₁₃₁ | a₂₃₁ | ΔT(50)₂₃₁ | a₃₃₁ | ΔT(50)₃₃₁ | a₄₃₁ | ΔT(50)₄₃₁ |
| Before steel | 1 | 1 | 1 | 1 | 1 | 1 | 1 | 1 |
| ball | | | | | | | | |
| dropping | | | | | | | | |
| test | | | | | | | | |
| After 1000 | 1 | 1 | 0.92 | 0.89 | 1 | 1 | 1 | 1 |
| times steel | | | | | | | | |
| ball | | | | | | | | |
| dropping | | | | | | | | |
| tests | | | | | | | | |
| After 5000 | 1 | 1 | 0.83 | 0.78 | 1 | 1 | 1 | 1 |
| times steel | | | | | | | | |
| ball | | | | | | | | |
| dropping | | | | | | | | |
| tests | | | | | | | | |

### Example 3

Similarly to the example 2 except for vibrating the measurement object by use of an impulse hammer in place of the vibration adder, the test of dropping the steel ball against the stainless steel plate was carried out. The result is shown in a table 3. Since the same result as the result in the example 2 was acquired also in the example, it was found that the analysis result could be acquired independently of the vibration adding method in the present invention.

TABLE 3

| | | | Position | | Position | | | |
|---|---|---|---|---|---|---|---|---|
| | Position 5 cm | | 15 cm | | 25 cm | | Position 35 cm | |
| | a₁₃ₖ/ | ΔT(50)₁₃ₖ/ | a₂₃ₖ/ | ΔT(50)₂₃ₖ/ | a₃₃ₖ/ | ΔT(50)₃₃ₖ/ | a₄₃ₖ/ | ΔT(50)₄₃ₖ/ |
| | a₁₃₁ | ΔT(50)₁₃₁ | a₂₃₁ | ΔT(50)₂₃₁ | a₃₃₁ | ΔT(50)₃₃₁ | a₄₃₁ | ΔT(50)₄₃₁ |
| Before steel | 1 | 1 | 1 | 1 | 1 | 1 | 1 | 1 |
| ball | | | | | | | | |
| dropping | | | | | | | | |
| test | | | | | | | | |
| After 1000 | 1 | 1 | 0.93 | 0.90 | 1 | 1 | 1 | 1 |
| times steel | | | | | | | | |
| ball | | | | | | | | |
| dropping | | | | | | | | |
| tests | | | | | | | | |
| After 5000 | 1 | 1 | 0.84 | 0.81 | 1 | 1 | 1 | 1 |
| times steel | | | | | | | | |
| ball | | | | | | | | |
| dropping | | | | | | | | |
| tests | | | | | | | | |

### Example 4

Similarly to the example 2 except for using a laser Doppler vibrometer in place of the vibration acceleration sensor, the test of dropping the steel ball against the stainless steel plate was carried out. The result is shown in a table 4. Since the same result as the result in the example 2 was acquired also in the example, it was found that the result did not depend on a kind of the sensor, which detected the vibration amplitude, in the present invention.

TABLE 4

| | | | Position | | Position | | | |
|---|---|---|---|---|---|---|---|---|
| | Position 5 cm | | 15 cm | | 25 cm | | Position 35 cm | |
| | a₁₃ₖ/ | ΔT(50)₁₃ₖ/ | a₂₃ₖ/ | ΔT(50)₂₃ₖ/ | a₃₃ₖ/ | ΔT(50)₃₃ₖ/ | a₄₃ₖ/ | ΔT(50)₄₃ₖ/ |
| | a₁₃₁ | ΔT(50)₁₃₁ | a₂₃₁ | ΔT(50)₂₃₁ | a₃₃₁ | ΔT(50)₃₃₁ | a₄₃₁ | ΔT(50)₄₃₁ |
| Before steel | 1 | 1 | 1 | 1 | 1 | 1 | 1 | 1 |
| ball | | | | | | | | |
| dropping | | | | | | | | |
| test | | | | | | | | |
| After 1000 | 1 | 1 | 0.93 | 0.87 | 1 | 1 | 1 | 1 |
| times steel | | | | | | | | |
| ball | | | | | | | | |
| dropping | | | | | | | | |
| tests | | | | | | | | |
| After 5000 | 1 | 1 | 0.85 | 0.79 | 1 | 1 | 1 | 1 |
| times steel | | | | | | | | |
| ball | | | | | | | | |
| dropping | | | | | | | | |
| tests | | | | | | | | |

### Example 5

Similarly to the example 2 except for adding the vibration to the structure by use of sound waves emitted by a speaker in place of the vibration adder, the test of dropping the steel ball against the stainless steel plate was carried out. The result is shown in a table 5. Since the same result as the result in the example 2 was acquired also in the example, it was found that the analysis result could be acquired independently of the vibration adding method in the present invention.

TABLE 5

| | | | Position | | Position | | | |
|---|---|---|---|---|---|---|---|---|
| | Position 5 cm | | 15 cm | | 25 cm | | Position 35 cm | |
| | a₁₃ₖ/ | ΔT(50)₁₃ₖ/ | a₂₃ₖ/ | ΔT(50)₂₃ₖ/ | a₃₃ₖ/ | ΔT(50)₃₃ₖ/ | a₄₃ₖ/ | ΔT(50)₄₃ₖ/ |
| | a₁₃₁ | ΔT(50)₁₃₁ | a₂₃₁ | ΔT(50)₂₃₁ | a₃₃₁ | ΔT(50)₃₃₁ | a₄₃₁ | ΔT(50)₄₃₁ |
| Before steel | 1 | 1 | 1 | 1 | 1 | 1 | 1 | 1 |
| ball | | | | | | | | |
| dropping | | | | | | | | |
| test | | | | | | | | |
| After 1000 | 1 | 1 | 0.94 | 0.88 | 1 | 1 | 1 | 1 |
| times steel | | | | | | | | |
| ball | | | | | | | | |
| dropping | | | | | | | | |
| tests | | | | | | | | |
| After 5000 | 1 | 1 | 0.86 | 0.80 | 1 | 1 | 1 | 1 |
| times steel | | | | | | | | |
| ball | | | | | | | | |
| dropping | | | | | | | | |
| tests | | | | | | | | |

### Example 6

Similarly to the example 1 except for using a stainless steel pipe whose length, an inner diameter and an outer diameter were 40 cm, 50 mm and 60 mm, respectively, the test of dropping the steel ball against the stainless steel plate was carried out. Then, in a state that both ends of the stainless steel plate were supported mechanically, the same analysis and evaluation were carried out similarly to the example 1. The result is shown in a table 6. Also in the example, similarly to the example 1, since it was found that, as number of the steel ball dropping tests increased, changes of the maximum value of vibration amplitude aᵢⱼₖ and the vibration continuation time ΔT(50)ᵢⱼₖ could be recognized clearly by use of only the vibration sensor which was arranged near the position where the steel ball was dropped, it was confirmed that it was possible to identify the degradation position and to evaluate a degree of degradation with high level accuracy. As mentioned above, in the present invention, it was found that it was possible to acquire the analysis result without depending on a shape of the measurement object. The result indicates that the present invention was applicable to a water service pipe, and plumbing which was used in a chemical plant.

TABLE 6

| | | | Position | | Position | | | |
|---|---|---|---|---|---|---|---|---|
| | Position 5 cm | | 15 cm | | 25 cm | | Position 35 cm | |
| | a₁₁ₖ/ | ΔT(50)₁₁ₖ/ | a₂₁ₖ/ | ΔT(50)₂₁ₖ/ | a₃₁ₖ/ | ΔT(50)₃₁ₖ/ | a₄₁ₖ/ | ΔT(50)₄₁ₖ/ |
| | a₁₁₁ | ΔT(50)₁₁₁ | a₂₁₁ | ΔT(50)₂₁₁ | a₃₁₁ | ΔT(50)₃₁₁ | a₄₁₁ | ΔT(50)₄₁₁ |
| Before steel | 1 | 1 | 1 | 1 | 1 | 1 | 1 | 1 |
| ball | | | | | | | | |
| dropping | | | | | | | | |
| test | | | | | | | | |
| After 1000 | 1 | 1 | 0.97 | 0.96 | 1 | 1 | 1 | 1 |
| times steel | | | | | | | | |
| ball | | | | | | | | |
| dropping | | | | | | | | |
| tests | | | | | | | | |
| After 5000 | 1 | 1 | 0.92 | 0.91 | 1 | 1 | 1 | 1 |
| times steel | | | | | | | | |
| ball | | | | | | | | |
| dropping | | | | | | | | |
| tests | | | | | | | | |

### Example 7

In the present example, a simulation on a case that physical properties of a whole of the stainless steel plate, which was the same as the stainless steel plate used in the example 1 (length, width, and thickness are 40 cm, 1 cm and 5 mm, respectively), are changed was carried out. The result is shown in a table 7. In the table 7, ‘a’ is the maximum value of vibration amplitude (value which is normalized by a reference value measured before degradation), and ΔT is the vibration continuation time (attenuation time) (value which is normalized by a reference value measured before degradation), and fr is the resonant frequency (value which is normalized by a reference value measured before degradation). On the assumption that the Young's modulus and the attenuation coefficient of the stainless steel plate before degradation were 1 and 1, respectively, and the Young's modulus after the degradation and the attenuation coefficient after the degradation were 0.98 and 1.06, respectively, the simulation was carried out by use of the finite element method.

TABLE 7

| state | Before degradation | After degradation |
|---|---|---|
| a | 1 | 0.97 |
| ΔT | 1 | 0.94 |
| fr | 1 | 0.99 |

As shown in the table 7, whereas the resonant frequency fr changed by 1% before and after degradation, the maximum value of vibration amplitude ‘a’ changed by 3%, and the vibration continuation time ΔT changed by 6%. It is conceivable that, even in the case that it is difficult to detect the degradation on the basis of the change of the resonant frequency since a change of the physical properties of the material is slight as mentioned above, it is possible to detect the degradation by comparing the value of the vibration amplitude or the vibration continuation time, which is measured in the state existing when carrying out the analysis, with the value of the vibration amplitude or the vibration continuation time, which is measured in the standard state since the change of the vibration amplitude or the vibration continuation time is large.

### INDUSTRIAL APPLICABILITY

The structure analyzing device and the structure analyzing method of the present invention are applicable to a structure made of stainless steel, aluminum alloy or concrete, and a vinyl chloride pipe. For example, the structure analyzing device and the structure analyzing method of the present invention are applicable to detecting water leak or destruction of a water service pipe in a water service system of a social infrastructure business, detecting degradation of a structure such as a building or a house, detecting petroleum leak or destruction of a pipeline in a petroleum pipe line system, and detecting gas leak in a gas pipeline or destruction of the pipeline. Use of the invention has no limitation and has wide scope.

The whole or part of the exemplary embodiments disclosed above can be described as, but not limited to, the following supplementary notes.

(Supplementary note 1) A structure analyzing device, comprising:

a vibration detecting means which detects a vibration of a structure; and

an analysis means which analyzes an output signal of the vibration detecting means, wherein

the analysis means analyzes a state change of the structure by comparing a value of at least one out of a vibration amplitude of the structure and a vibration continuation time of the structure, which is measured in a state existing when carrying out analysis, with a value of at least one out of a vibration amplitude of the structure and a vibration continuation time of the structure which is measured in a standard state.

(Supplementary note 2) The structure analyzing device according to addition 1, wherein

the standard state is a state before the state change occurs in the structure.

(Supplementary note 3) The structure analyzing device according to addition 1 or 2, wherein

the value in the standard state is stored in a storage means, and wherein

the analysis means reads the value in the standard state from the storage means, and compares the value in the state existing when carrying out the analysis, with the value in the standard state.

(Supplementary note 4) The structure analyzing device according to any one of additions 1 to 3, comprising:

a plurality of the vibration detecting means, wherein

the plural vibration detecting means are arranged at locations different each other.

(Supplementary note 5) The structure analyzing device according to any one of additions 1 to 4, wherein

the vibration detecting means is a non-contact type vibration detecting means.

(Supplementary note 6) The structure analyzing device according to any one of additions 1 to 4, wherein

the vibration detecting means is a contact type vibration detecting means.

(Supplementary note 7) The structure analyzing device according to any one of additions 1 to 6, further comprising:

a vibration adding means which vibrates the structure.

(Supplementary note 8) The structure analyzing device according to addition 7, wherein

the vibration adding means adds a vibration, which includes a high order resonant frequency component, to the structure, and causes the structure mechanical distortion, and wherein

the vibration detecting means is arranged at a position at which the mechanical distortion is caused, and the state change of the structure is analyzed on the basis of an output signal of the vibration detecting means.

(Supplementary note 9) A non-destructive inspection apparatus, comprising:

the structure analyzing device according to any one of additions 1 to 8.

(Supplementary note 10) A structure analyzing method, comprising:

a vibration detecting step in which a vibration of a structure is detected; and

an analysis step in which an output signal in the vibration detecting step is analyzed, wherein

in the analysis step, a state change of the structure is analyzed by comparing a value of at least one out of a vibration amplitude of the structure and a vibration continuation time of the structure, which is measured in a state existing when carrying out analysis, with a value of at least one out of a vibration amplitude of the structure and a vibration continuation time of the structure which is measured in a standard state.

(Supplementary note 11) The structure analyzing method according to addition 10, wherein

the standard state is a state before the state change occurs in the structure.

(Supplementary note 12) The structure analyzing method according to addition 10 or 11, wherein

the value in the standard state is stored, and wherein

in the analysis step, the stored value measured in the standard state is read, and the value in the state existing when carrying out the analysis, is compared with the value in the standard state.

(Supplementary note 13) The structure analyzing method according to any one of additions 10 to 12, wherein

a plurality of vibrations are detected at locations different each other in the vibration detecting step.

(Supplementary note 14) The structure analyzing method according to any one of additions 10 to 13, further comprising:

a vibration adding step in which a structure is vibrated and which is carried out before the vibration detecting step.

(Supplementary note 15) The structure analyzing method according to addition 14, wherein

the vibration adding step is a step in which a vibration including a high order resonant frequency component is added to the structure, and in which by adding the vibration, cause the mechanical distortion to the structure, wherein

in the vibration detecting step, a vibration of the structure caused at a position, at which the mechanical distortion is caused, is detected, and wherein

in the analysis step, the state change of the structure is analyzed on the basis of an output signal related to the vibration of the structure arranged at the position at which the mechanical distortion is caused.

(Supplementary note 16) A non-destructive inspection method which uses the structure analyzing method according to any one of additions 10 to 15.

(Supplementary note 17) A water leak analyzing device, comprising:

the structure analyzing device according to any one of additions 1 to 8, wherein

the vibration detecting means detects a vibration of a water service pipe, and wherein

a degradation state of the water service pipe is analyzed by comparing a value of at least one out of a vibration amplitude of the water service pipe and a vibration continuation time of the water service pipe, which is measured in a state existing when carrying out analysis, with a value of at least one out of a vibration amplitude of the water service pipe and a vibration continuation time of the water service pipe which is measured in a standard state.

(Supplementary note 18) A water leak analyzing method which uses the structure analyzing method according to any one of additions 10 to 15, wherein

the vibration detecting step is a step in which a vibration of a water service pipe is detected, and wherein

a degradation state of the water service pipe is analyzed by comparing a value of at least one out of a vibration amplitude of the water service pipe and a vibration continuation time of the water service pipe, which is measured in a state existing when carrying out analysis, with a value of at least one out of a vibration amplitude of the water service pipe and a vibration continuation time of the water service pipe which is measured in a standard state.

While the invention has been particularly shown and described with reference to exemplary embodiments and examples thereof, the invention is not limited to these embodiments and examples. It will be understood by those of ordinary skill in the art that various changes in form and details may be made therein without departing from the spirit and scope of the present invention as defined by the claims.

This application is based upon and claims the benefit of priority from Japanese Patent Application No. 2012-129200, filed on Jun. 6, 2012, the disclosure of which is incorporated herein in its entirety by reference.

### REFERENCE SIGNS LIST

10 and 20 structure analyzing device
11 vibration detecting means
12 analysis means
13 vibration adding means
14 control means
21 constant voltage oscillation circuit
22 and 37 vibration adder
23 structure of analysis object (measurement object)
24 vibration acceleration sensor
25 analysis unit
26 reference data storing apparatus
27 arithmetic unit
28 analysis means
31, 32, 33, and 34 vibration sensor
38 measurement object
39 pedestal
1 member
2 fluorescent material
3 crack
4 ultrasonic transducer

1. A structure analyzing device, comprising:
a vibration detecting unit which detects a vibration of a structure; and
an analysis unit which analyzes an output signal of the vibration detecting unit, wherein the analysis unit analyzes a state change of the structure by comparing a value of at least one out of a vibration amplitude of the structure and a vibration continuation time of the structure, which is measured in a state existing when carrying out analysis, with a value of at least one out of a vibration amplitude of the structure and a vibration continuation time of the structure which is measured in a standard state.

2. The structure analyzing device according to claim 1, wherein
the standard state is a state before the state change occurs in the structure.

3. The structure analyzing device according to claim 1, wherein
the value, in the standard state is stored in a storage unit, and wherein
the analysis unit reads the value, in the standard state from the storage unit, and compares the value, in the state existing when carrying out the analysis, with the value in the standard state.

4. The structure analyzing device according to claim 1, comprising:
a plurality of the vibration detecting unit, wherein
the plural vibration detecting unit are arranged at locations different each other.

5. The structure analyzing device according to claim 1, wherein the vibration detecting unit is a non-contact type vibration detecting unit.

6. The structure analyzing device according to claim 1, wherein the vibration detecting unit is a contact type vibration detecting unit.

7. The structure analyzing device according to claim 1, further comprising:
a vibration adding unit which vibrates the structure.

8. The structure analyzing device according to claim 7, wherein
the vibration adding unit adds a vibration, which includes a high order resonant frequency component, to the structure, and causes the structure mechanical distortion, and wherein
the vibration detecting unit is arranged at a position at which the mechanical distortion is caused, and the state change of the structure is analyzed on the basis of an output signal of the vibration detecting unit.

9. A non-destructive inspection apparatus, comprising:
the structure analyzing device according to claim 1.

10. A structure analyzing method, comprising:
detecting vibration of a structure; and
analyzing an output signal being output, wherein
analyzing a state change of the structure, by comparing a value of at least one out of a vibration amplitude of the structure and a vibration continuation time of the structure, which is measured in a state existing when carrying out analysis, with a value of at least one out of a vibration amplitude of the structure and a vibration continuation time of the structure which is measured in a standard state.

11. The structure analyzing method according to claim 10, wherein
the standard state is a state before the state change occurs in the structure.

12. The structure analyzing method according to claim 10, wherein
the value, in the standard state is stored, and wherein
reading the stored value measured in the standard state, and comparing the value in the state existing when carrying out the analysis, with the value in the standard state.

13. The structure analyzing method according to claim 10, wherein detecting a plurality of vibrations are detected at locations different each other.

14. The structure analyzing method according to claim 10, further comprising:
vibrating a structure, before detecting a vibration of a structure.

15. The structure analyzing method according to claim 14, wherein
adding a vibration including a high order resonant frequency component of the structure, and in which by adding the vibration, cause the mechanical distortion to the structure, wherein
detecting a vibration of the structure caused at a position, at which the mechanical distortion is caused, and wherein
analyzing the state change of the structure, on the basis of an output signal related to the vibration of the structure existing at the position at which the mechanical distortion is caused.

16. A non-destructive inspection method which uses the structure analyzing method according to claim 10.

17. The structure analyzing device according to claim 2, wherein
the value, in the standard state is stored in a storage unit, and wherein
the analysis unit reads the value, in the standard state from the storage unit, and compares the value, in the state existing when carrying out the analysis, with the value in the standard state.

18. The structure analyzing device according to claim 2, comprising:
a plurality of the vibration detecting unit, wherein
the plural vibration detecting unit are arranged at locations different each other.

19. The structure analyzing device according to claim 3, comprising:
a plurality of the vibration detecting unit, wherein the plural vibration detecting unit are arranged at locations different each other.

20. The structure analyzing device according to claim 2, wherein
the vibration detecting unit is a non-contact type vibration detecting unit.
